(19) United States
(12) Patent Application Publication
(10) Pub. No.: US 2016/0128480 A1
(43) Pub. Date: May 12, 2016

(54) Portable Easel

(71) Applicant: John Stevens, Millbrook, NY (US)

(72) Inventor: John Stevens, Millbrook, NY (US)

(21) Appl. No.: 14/880,360

(22) Filed: Oct. 12, 2015

Related U.S. Application Data
(60) Provisional application No. 62/076,830, filed on Nov. 7, 2014.

(51) Int. Cl. A47B 97/08; F16M 11/32; F16M 11/26; F16M 11/06; F16M 11/14

(52) U.S. Cl. CPC A47B 97/08; F16M 11/06; F16M 11/14; F16M 11/26; F16M 11/32

(57) ABSTRACT

A portable easel for allowing a user to conveniently transport art supplies and a drawing surface to various locations. The portable easel includes an easel board removably and pivotally secured to a tripod base, wherein one or more legs of the tripod base are independently adjustable in length so as to allow for the easel to be positioned on an uneven support surface, such as a hill. Further, the tripod base may be folded into a compact configuration to conveniently transport the easel. The easel board is secured to the tripod base by a ball and socket connection, wherein the easel board can rotate thereon to allow a user to draw, paint, and the like at various angles. In some embodiments, the easel board includes one or more lights thereon so as to illuminate the drawing surface and a storage band removably securable to the easel board that can hold art supplies therein.

### CROSS REFERENCE TO RELATED APPLICATION

This application claims the benefit of U.S. Provisional Application No. 62/076,830 filed on Nov. 7, 2014. The above identified patent application is herein incorporated by reference in its entirety to provide continuity of disclosure.

### BACKGROUND OF THE INVENTION

### Field of the Invention

The present invention relates to adjustable easel devices. More specifically, the present invention provides a portable easel comprising an easel board removably and pivotally secured to a tripod base, wherein one or more legs of the tripod base are independently adjustable so as to allow for the easel to be positioned on an uneven support surface, such as a hill. In some embodiments, the easel board includes one or more lights thereon so as to illuminate the drawing surface and a storage band removably securable to the easel board that can hold art supplies therein.

Many artists paint or draw while outdoors in order to illustrate a scenic landscape. However, working outdoors poses several challenges. First, it can be difficult to find a level surface on which to place a traditional easel, causing the easel to be unstable or unbalanced. Further, the artists may not have sufficient light to view the canvas on the easel and the artists has no means for providing additional light. Additionally, conventional easels are bulky and cannot be easily transported or carried. Thus, the present invention provides an easel that is more portable and suited for use outdoors.

Devices have been disclosed in the prior art that relate to adjustable easels. These include devices that have been patented and published in patent application publications. These devices generally relate to an easel board mounted to a base, such as U.S. Pat. No. 7,717,393, U.S. Pat. No. 4,165,856, U.S. Patent Application Publication Number 2013/0256495, U.S. Patent Application Publication Number 2013/0105659, and U.S. Pat. No. 5,725,192.

These prior art devices have several known drawbacks. The devices in the prior art provide an easel board attached to a base, but fail to provide an easel board removably secured to a tripod base via a ball and socket connection so as to allow the present invention to be stored and transported in a compact configuration, as well as allow the easel board to be rotated to various angles. Further, the prior art fails to provide a storage band securable to the easel board so as to conveniently hold art supplies therein.

In light of the devices disclosed in the prior art, it is submitted that the present invention substantially diverges in design elements from the prior art and consequently it is clear that there is a need in the art for an improvement to existing portable easels. In this regard the instant invention substantially fulfills these needs.

### SUMMARY OF THE INVENTION

In view of the foregoing disadvantages inherent in the known types of portable easels now present in the prior art, the present invention provides a new portable easel wherein the same can be utilized for providing convenience for the user when transporting an easel to various locations.

It is therefore an object of the present invention to provide a new and improved portable easel that has all of the advantages of the prior art and none of the disadvantages.

It is another object of the present invention to provide a portable easel comprising an easel board removably and pivotally secured to a tripod base via a ball a socket connection so as to allow the easel board to rotate and allow a user to illustrate thereon at various angles.

Another object of the present invention is to provide a portable easel wherein the tripod base is foldable and comprises one or more legs that are adjustable in length so as to allow the easel to be disposed on an uneven support surface, such as a hill.

Yet another object of the present invention is to provide a portable easel comprising one or more lights disposed on the easel board so as to illuminate a drawing surface thereon.

Yet another object of the present invention is to provide a portable easel comprising a storage band removably securable to the easel board, wherein the storage band is adapted to hold art supplies therein.

Another object of the present invention is to provide a portable easel that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the portable easel.

FIG. 2 shows a perspective view of the upper end of the portable device wherein the easel board is positioned for attachment to the base.

FIG. 3 shows a perspective view of one or more lights disposed on the easel board of the portable easel.

FIG. 4 shows a perspective view of a storage band disposed around the easel board of the portable easel.

### DETAILED DESCRIPTION OF THE INVENTION

Reference is made herein to the attached drawings. Like reference numerals are used throughout the drawings to depict like or similar elements of the portable easel. For the purposes of presenting a brief and clear description of the present invention, the preferred embodiment will be discussed as used for allowing a user to conveniently transport art supplies and a drawing surface to various locations. The figures are intended for representative purposes only and should not be considered to be limiting in any respect.

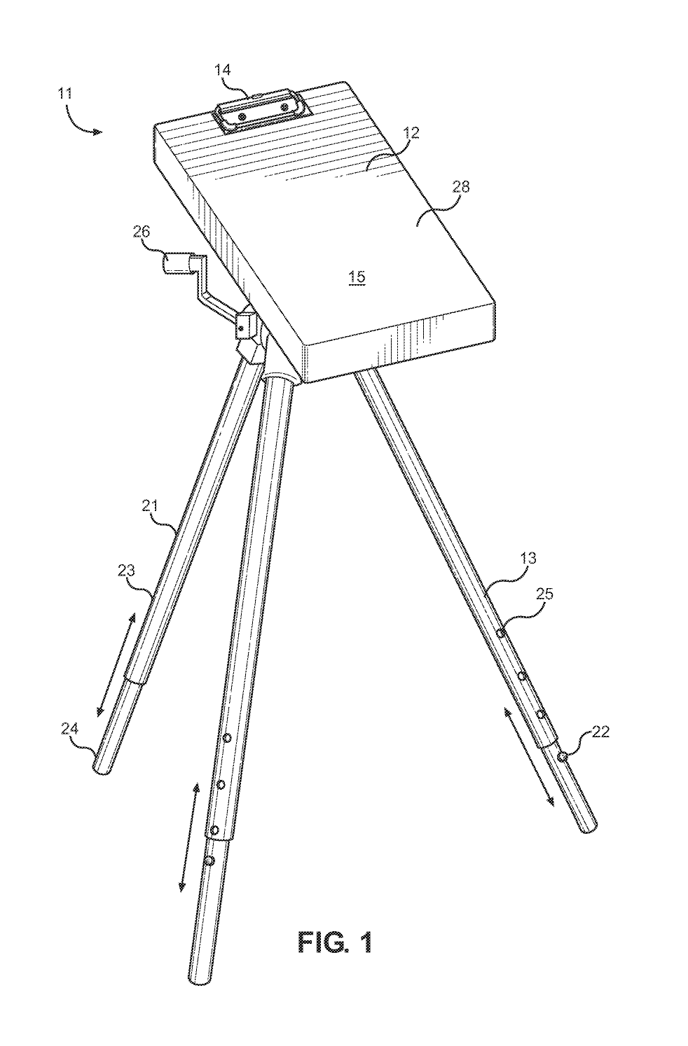

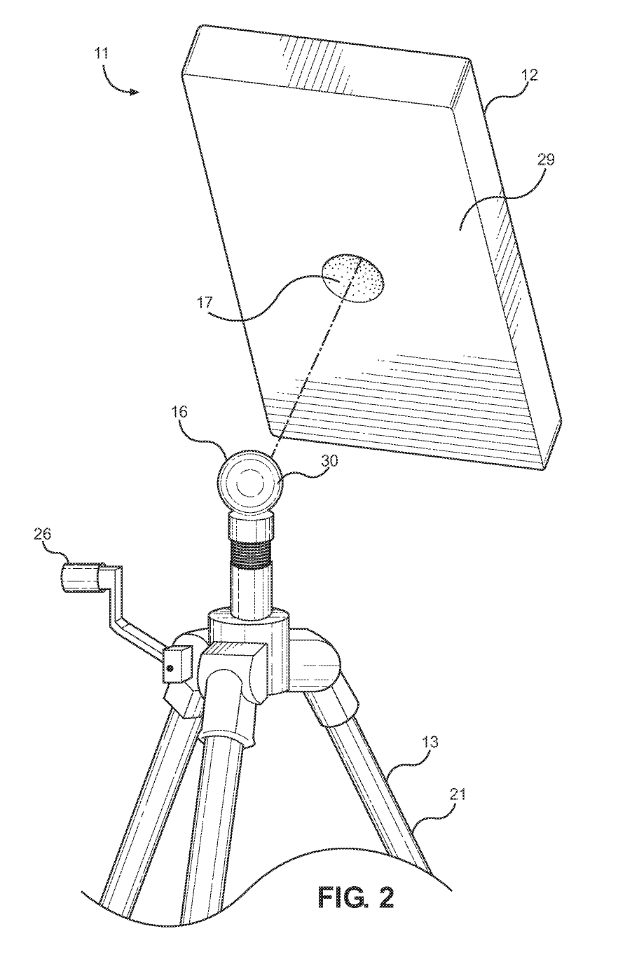

Referring now to FIGS. 1 and 2, there is shown a perspective view of an embodiment of the portable easel and a perspective view of the upper end of the portable device wherein the easel board is positioned for attachment to the base, respectively. The portable easel 11 provides a surface for a user to paint, draw, sketch, and the like thereon. The portable easel 11 comprises an easel board 12 removably and pivotally secured to a base, wherein the base is preferably a tripod base 13. The legs 21 of the tripod base 13 are independently adjustable in length. The independent adjustment of the legs 21 allow for the tripod base 13 to be disposed on curved and uneven support surfaces, such as a hill. Preferably, each leg 21 of the tripod base 13 is telescopic and includes a first rod 23 adapted to fit over a second rod 24, thereby allowing the leg 21 to be adjusted in length. One or more apertures 25 are disposed along the length of the first rod 23, wherein a fastener, such as a push lock pin 22, is disposed on the second rod 24 and adapted to align with and fit through an aperture 25 to allow the leg 21 to remain in the desired position.

The tripod base 13 is further movable from an extended configuration to a stored configuration. In the illustrated embodiment, the legs 21 are operably connected to a handle 26 disposed on the tripod base 13, wherein the handle 26 is adapted to be rotated in one direction to move the lower ends of the legs 21 closer toward one another. The handle 26 is mechanically connected to the legs 21 via one or more gears disposed within the tripod base 13. The handle 26 is further adapted to be rotated in the opposing direction to move the lower ends of the legs 21 outwards from one another. However, in other embodiments, the legs 21 are manually movable by directly adjusting the position of the legs 21, rather than rotating a handle 26 in order to move the legs 21. The upper end of each leg 21 is connected at a common point, whereas the lower end of each leg 21 is free. In the extended configuration, the lower ends of the legs 21 are separated from one another, whereas the tripod base 13 may stably rest on a support surface. In the stored configuration the lower ends of the legs 21 are disposed substantially parallel to one another in a compact formation.

The easel board 12 comprises a front wall 28 and a rear wall 29, wherein the surface 15 of the front wall 28 is planar and adapted to receive a canvas thereon. The front wall 28 further comprises one or more fasteners, such as clips 14, that are adapted to removably secure a sketch pad, paper, or other type of canvas thereto. In the illustrated embodiment, a clip 14 is disposed on an upper end of the front wall 28. Preferably, the easel board 12 is rectangular in shape so as to correspond to a rectangular shaped paper or canvas. However, in other embodiments, the easel board 12 can comprise any suitable shape so as to correspond to alternatively shaped papers or canvases, such as circular. In some embodiments, the easel board 12 comprises an interior compartment accessible via a door on the front wall that is adapted to receive art supplies therein.

The rear wall 29 of the easel board 12 is removably and pivotally secured to the upper end 30 of the tripod base 13. In the illustrated embodiment, the rear wall 29 comprises a socket joint 17 for receiving a ball joint 16 disposed on the tripod base 13. The ball and socket connection 16, 17 allow the easel board 12 to rotate at various angles, thus allowing the user to illustrate at a convenient and comfortable angle for achieving his or her desired artwork. The dimension of the socket joint 17 is adapted to allow the ball joint 16 to fit securely therein so the easel board 12 can remain securely attached to the base 13. Further, the easel board 12 is adapted to remain in the position in which it is disposed until the user desires to rotate the easel board 12. In some embodiments, the ball and socket connection 16, 17 comprise a locking mechanism to further secure the easel board 12 in a position in which it is disposed, such as a push locking pin.

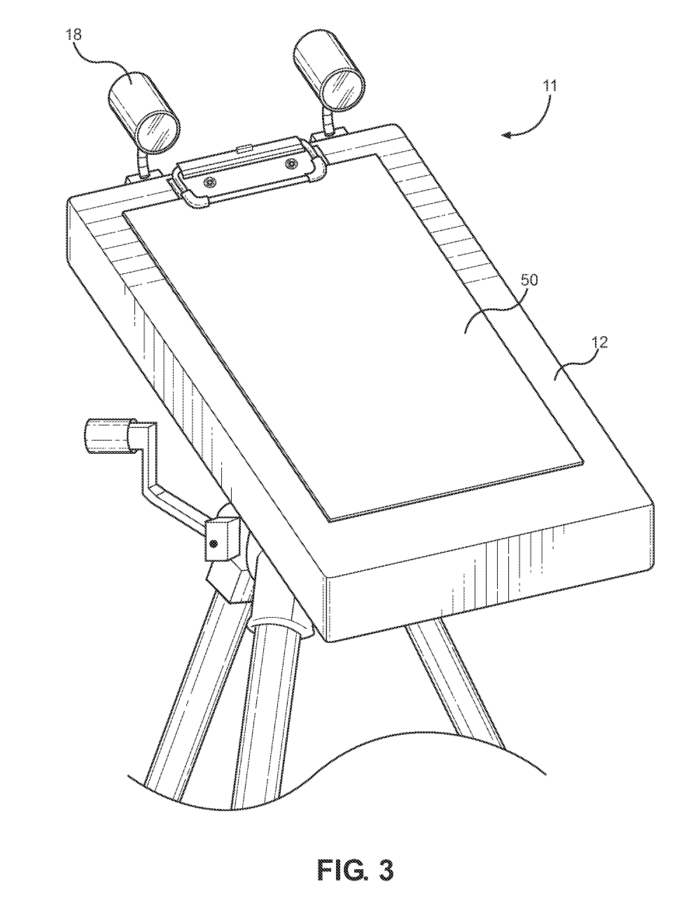

Referring now to FIG. 3, there is shown a perspective view of one or more lights disposed on the easel board of the portable easel. In some embodiments, the portable easel 11 comprises one or more lights 18 disposed on the easel board 12 and adapted to illuminate the front surface thereof, including a paper 50 or canvas disposed thereon. The lights 18 are secured on the upper end of the easel board 12 and extend upward therefrom. In the illustrated embodiment, the lights 18 are mounted on adjustable arms so that the lights 18 can be directed into a desired position. The arms are composed of a flexible material so that they can be easily adjusted. The lights 18 can be secured to the easel board 12 by any suitable fastener, such as screws. The lights 18 are preferably LED lights but may include other sources of illumination. In the illustrated embodiment, a pair of lights 18 are used, however in alternate embodiments one or more lights 18 can be secured to the easel board 12. The lights 18 further include a power source, such as one or more batteries therein. In alternate embodiments, the lights 18 are removably secured to the easel board 12 so as to allow for the compact storage of the portable easel 11.

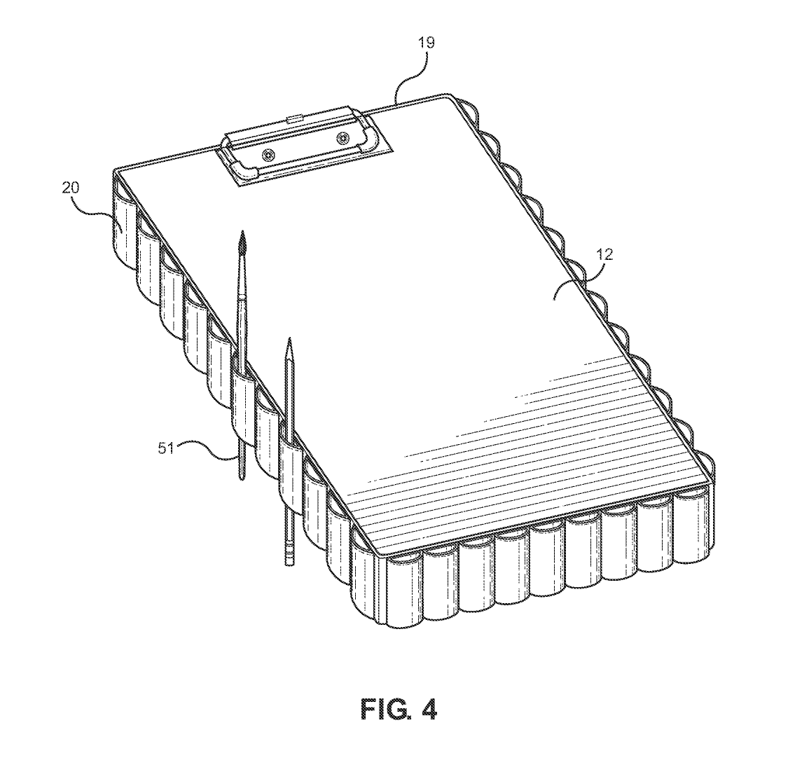

Referring now to FIG. 4, there is shown a perspective view of a storage band disposed around the easel board of the portable easel. In some embodiments, the portable easel 11 further comprises a storage band 19 that is removably securable to the easel board 12. The storage band 19 comprises a loop configuration adapted to be positioned around the edges of the easel board 12. The storage band 19 further comprises a plurality of securement mechanisms 20 configured to receive and hold art supplies 51 therein. The securement mechanisms 20 comprise a first end and a second end, wherein the ends are disposed along the exterior side of the band 19, thereby forming an opening therebetween. Preferably, the securement mechanism 20 is composed of a stretchable material, such as elastic, in order to frictionally hold art supplies in the opening. The interior side of the band 19 is positioned flush against the easel board 12. In the illustrated embodiment, the storage band 19 is composed of stretchable material so as to securely fit around the easel board 12. However, in alternate embodiments, the storage band 19 comprises a line of separation and a fastener disposed on either separated end, such as Velcro, that allows the ends to be removably secured to one another. In this way, the storage band 19 can be wrapped around the edges of the easel board 12 and removably secured thereto.

In operation, the portable easel 11 provides a transportable studio for artists and painters. The tripod base is disposed in an extended configuration, wherein the easel board is secured thereto at a desired angle. The lights are adapted to be utilized if the scenic environment is poorly lit. The storage band is positioned around the easel board, wherein art supplies are stored through the opening thereof in order to avoid a user having to place art supplies on the ground if a table is unavailable. In this way, the portable easel provides quick and convenient access to a drawing surface and art supplies for artists, painters, caricaturists, children, and the like.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A portable easel, comprising:
an easel board having a front wall and a rear wall, wherein said front wall is adapted to receive a canvas thereon;
a base having an upper end and a lower end, wherein said upper end is pivotally and removably secured to said easel board;
wherein said base comprises one or more legs, wherein each of said one or more legs are independently adjustable in length so as to allow said base to rest on an uneven support surface.

2) The portable easel of claim 1, further comprising a storage band secured to said easel board and adapted to hold art supplies therein.

3) The portable easel of claim 1, wherein said easel board is pivotally and removably secured to said base via a ball and socket connection.

4) The portable easel of claim 1, wherein said base is a tripod having one or more legs that are adjustable in length.

5) The portable easel of claim 4, further comprising a handle disposed on said base and mechanically connected to one or more legs of said tripod so as to move a lower end of said one or more legs inwards and outwards from one another, such that said tripod is movable between an extended and a stored configuration.

6) The portable easel of claim 1, further comprising one or more lights disposed on said easel board.

7) The portable easel of claim 1, wherein said easel board comprises one or more clips disposed on said front wall thereof and adapted to removably secure said canvas thereto.

8) A portable easel, comprising:
an easel board having a front wall and a rear wall, wherein said front wall is adapted to receive a canvas thereon;
a base having an upper end and a lower end, wherein said upper end is pivotally and removably secured to said easel board;
wherein said easel board is pivotally and removably secured to said base via a ball and socket connection;
wherein said base comprises one or more legs, wherein each of said one or more legs are independently adjustable in length so as to allow said base to rest on an uneven support surface;
one or more clips disposed on said front wall thereof and adapted to removably secure said canvas thereto;
one or more lights disposed on an upper end of said easel board.
